(19) United States
(12) Patent Application Publication
(10) Pub. No.: US 2017/0014983 A1
(43) Pub. Date: Jan. 19, 2017

(54) CHISELING HANDHELD POWER TOOL

(71) Applicant: Hilti Aktiengesellschaft, Schaan (LI)

(72) Inventors: Udo Hauptmann, Landsberg (DE); Aaron Wiedner, Landsberg (DE); Makus Hauptmann, Mauerstetten (DE)

(73) Assignee: Hitlti Aktiengesellschaft, Schaan (LI)

(21) Appl. No.: 15/125,060

(22) PCT Filed: Mar. 10, 2015
(86) PCT No.: PCT/EP2015/054919

§ 371 Date: Sep. 9, 2016

(30) Foreign Application Priority Data
Mar. 12, 2014 (EP) 14159121.4

(51) Int. Cl. B25D 11/00; B25D 17/06

(52) U.S. Cl. CPC B25D 11/005; B25D 17/06; B25D 2211/068; B25D 2217/0015; B25D 2250/131; B25D 2250/225

(57) ABSTRACT

The striking pin (16) is arranged in a bearing (29). The striking pin (16) has a circumferential surface (25) and a stop surface (27) facing in the striking direction (11). The bearing (29) has a sleeve (30) arranged coaxially to the working axis (10) as well as a catcher (32). The circumferential surface (25) of the striking pin (16) is installed so as to slide on the inside of the sleeve (30). The catcher (32) is arranged in the striking direction (11) of the stop surface (27) of the striking pin (16) in order to limit the movement of the striking pin (16) in the striking direction (11). A connecting link (35) is provided for purposes of causing the striking pin (16) to execute a rotation relative to the bearing (29) when the striking pin (16) moves in the striking direction (11). The connecting link (35) has a flank (42; 53) on the striking pin (16) and another flank (49; 52) on the bearing (29), whereby the two flanks (42; 53, 49; 52) that rest against each other during the movement rise in the striking direction (11) in the same circumferential direction (39).

The present invention relates to a chiseling handheld power tool with an idle strike cut-off.

U.S. Pat. Appln. No. 2002/0050191 A describes a hand-held power tool of the generic type, having a striker that is coupled to an exciter by means of a pneumatic spring. The striking mechanism has a striking pin which, in case of an idle strike, can move out of the working position into an advanced position in the striking direction. Now the striker can likewise advance further in the striking direction, thereby opening the vent of the pneumatic spring. The pneumatic spring remains deactivated until the striking pin is pushed back into the working position by a drill bit or chisel that is pressed against the substrate. The striker, which is likewise moved in this process, closes the vent and the pneumatic spring is once again activated.

The deactivation of the pneumatic spring is dependent on the striking pin remaining in the advanced position.

### SUMMARY OF THE INVENTION

It is an object of the present invention to provide a handheld power tool having a tool socket to hold a chiseling tool coaxially to a working axis. Along the working axis, a striking mechanism consecutively has an exciter, a pneumatic chamber, a striker and a striking pin. The exciter is forcibly excited by the motor periodically. The striker is installed so that it can be moved coaxially to the working axis. The pneumatic chamber is configured between the exciter and the striker so as to couple a movement of the striker to the movement of the exciter. The striking pin is arranged behind the striker in the striking direction for purposes of indirectly transmitting an impact from the striker to a tool that is held in the tool socket. The striking pin is arranged in a bearing. The striking pin has a circumferential surface and a stop surface facing in the striking direction. The bearing has a sleeve arranged coaxially to the working axis as well as a catcher. The circumferential surface of the striking pin can slide on the inside of the sleeve. The catcher is arranged in the striking direction of the stop surface of the striking pin in order to limit the movement of the striking pin in the striking direction. A connecting link is provided for purposes of causing the striking pin to execute a rotation relative to the bearing when the striking pin moves in the striking direction. The connecting link has a flank on the striking pin and another flank on the bearing, whereby the two flanks that rest against each other during the movement rise in the striking direction in the same circumferential direction.

During an idle strike, the striking pin rotates relative to the bearing. It turns out that the conversion of the axial movement into the rotational movement entails high losses, as a result of which the striking pin advantageously comes to a halt in the vicinity of the catcher.

The connecting link can have a set of teeth on the end face of the striking pin and a set of teeth on the catcher. These sets of end face teeth are preferably configured so as to be complementary to each other. When the striking pin strikes into the catcher, the sets of end face teeth are oriented towards each other, thereby causing the striking pin or the catcher to rotate.

The bearing can be mounted in the power tool housing so as to be freely rotatable around the working axis. In particular, the bearing is decoupled from a drive shaft. The freely rotatable catcher can rest against an elastic damping element in the striking direction. The friction between the damping element and the catcher stops the striking pin. Moreover, the damping element ensures that, at the working point, the catcher is always situated at its rear stop, so that, in case of an idle strike, it can make an axial movement in the direction of the tool, and this movement is limited by the stop in the guide tube. Additional energy is removed from the striking pin by this additional impact process.

The connecting link can have a spiral groove that forms the flank in a cylindrical circumferential surface of the striking pin and a runner that engages into the groove from the bearing. By the same token, the connecting link can have a spiral groove that forms the flank in a cylindrical inner surface of the bearing and a runner that engages into the groove from the striking pin.

### BRIEF DESCRIPTION OF THE DRAWINGS

The description below explains the invention on the basis of embodiments and figures provided by way of an example. The figures show the following:

FIG. 1: a hammer drill; FIG. 2: a striking mechanism of the hammer drill;

FIG. 3: a striking pin and the guide of the striking mechanism;

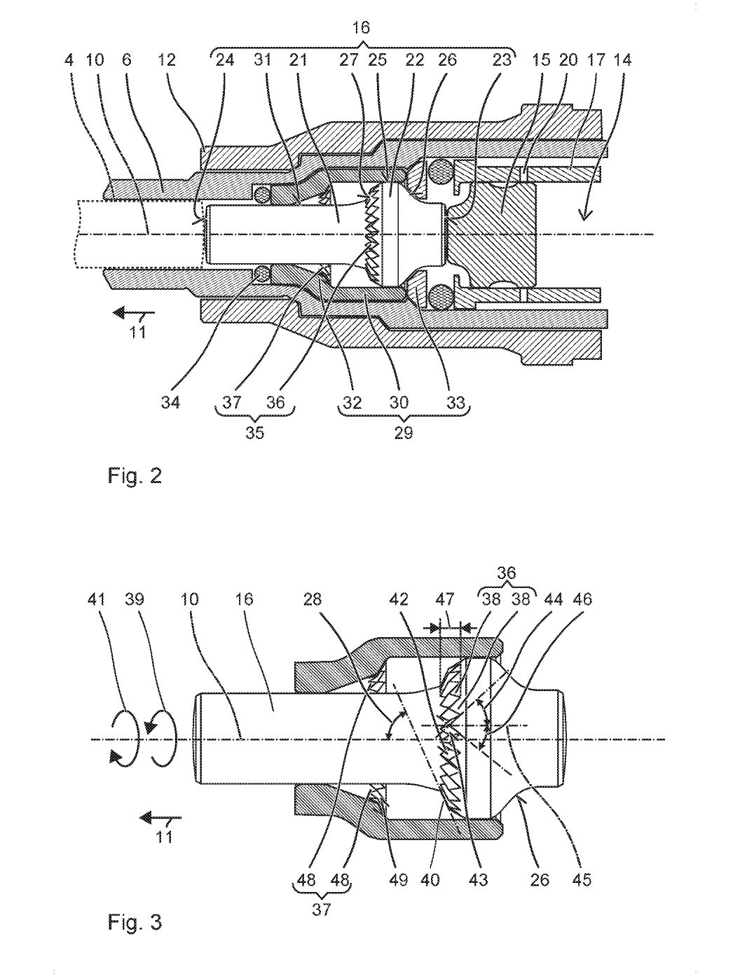

FIG. 4: a striking mechanism of the hammer drill.

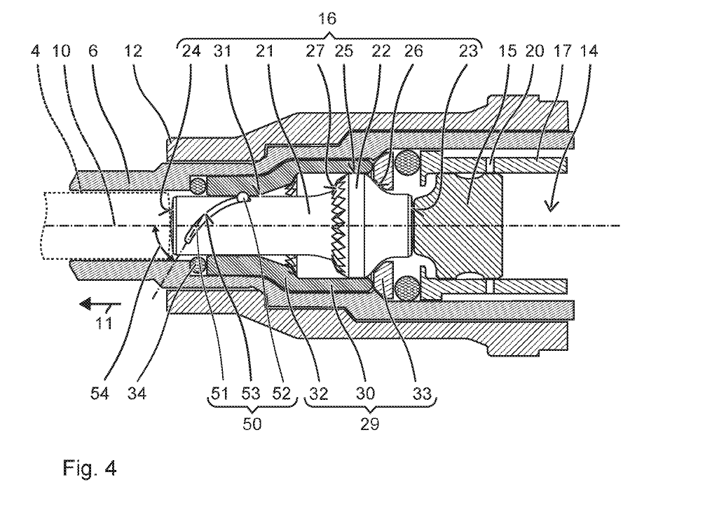

Unless otherwise indicated, the same or functionally identical elements are designated in the figures by the same reference numerals. Unless otherwise indicated, the arrangement of the elements is described relative to the working axis and the striking direction. A front element is situated in front of a rear element as seen in the striking direction.

### SUMMARY OF THE INVENTION

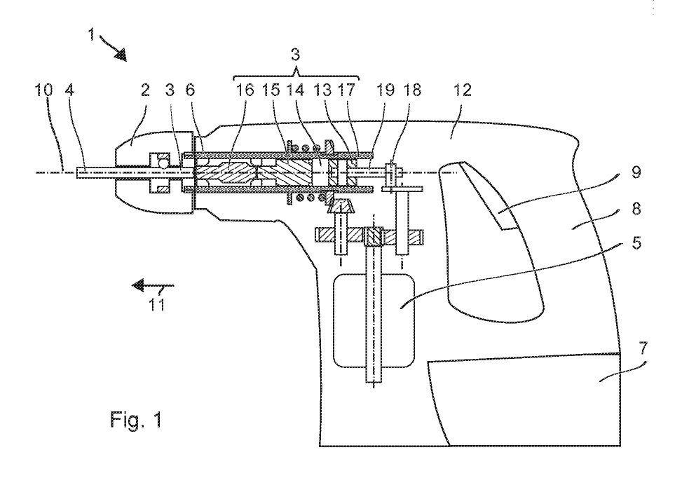

FIG. 1 schematically shows a hammer drill 1 as an example of a chiseling hand-held power tool. The hammer drill 1 has a tool socket 2 into which one shank end 3 of a tool, for example, a drill bit 4, can be inserted. The primary drive of the hammer drill 1 is in the form of a motor 5 that drives a pneumatic striking mechanism 3 and a driven shaft 6. A battery pack 7 or a mains line supply the motor 5 with power. A user can hold the hammer drill 1 by means of a handle 8 and put the hammer drill 1 into operation by means of a system switch 9. During operation, the hammer drill 1 rotates the drill bit 4 continuously around a working axis 10 and, in this process, it can hammer the drill bit 4 into a substrate in the striking direction 11 along the working axis 10. The striking mechanism 3 and the additional drive components are arranged inside the power tool housing 12.

The pneumatic striking mechanism 3 has a piston-shaped exciter 13, a pneumatic chamber 14, a piston-shaped striker 15 and a striking pin 16 that are arranged on the working axis 10 and that run along the working axis 10. The exciter 13 and the striker 15 are arranged, for example, in a stationary guide tube 17. The striker can also be arranged in a pot-shaped exciter whose tubular wall forms the guide tube for the striker; analogously, the striker can also be configured so as to be pot-shaped. The exciter 13 is connected to the motor 5 by means of a gear unit that converts the rotational movement of the motor 5 into a periodically back-and-forth linear movement of the exciter 13 along the working axis 10. For instance, the gear unit comprises an eccentric 18 that is driven by the motor 5 and that is joined to the exciter 13 via a connecting rod 19. The gear unit can also have a toggle drive. The pneumatic chamber 14 is closed off by the exciter 13 and the striker 15. The motor-driven periodical movement of the exciter 13 increases the air pressure in the pneumatic chamber 14 vis-à-vis the ambient pressure. The freely moveable striker 15 is accelerated away from the exciter 13 in the striking direction 11 or else, at a reduced air pressure, towards the exciter 13. The movement of the striker 15 is coupled to the movement of the exciter 13 by the pneumatic chamber 14, also referred to as a pneumatic spring. During operation, the striker 15 oscillates between a front turning point at which the exciter 13 and the striker 15 compress the pneumatic chamber 14 to the maximum, and a rear turning point (strike point) at which the striker 15 strikes the striking pin 16.

During operation, the striking pin 16 is held in a working position by a tool 4 that is pressed against the substrate, and this working position coordinates the distance between the turning points in such a way that the periodicity of the movement of the striker 15 coincides with the periodicity of the movement of the exciter 13. If there is no contact pressure from the tool 4, for instance, because the user has lifted the hammer drill 1 off of the substrate, the striking pin 16 leaves the working position in the striking direction 11. The striker 15 flies beyond the strike point in the striking direction 11. In this process, a vent 20 is freed which allows an air exchange between the pneumatic chamber 14 and the environment, thus deactivating the pneumatic spring. The striker 15 is no longer coupled to the exciter 13 and the striking mechanism 3 switches off automatically. The striking pin 16 preferably remains outside of the working position. As soon as the user once again presses the tool 4 against the substrate, the striking pin 16 is moved into the working position and the vent 20 is closed. The striking mechanism 3 switches on again automatically.

The vents 20 given by way of example are situated in radial openings in the guide tube 17 that seal off the striker 15 vis-à-vis the pneumatic chamber 14 during operation. The vents 20 are offset relative to the pneumatic chamber 14 in the striking direction 11 when the striker 15 is in front of the strike point in the striking direction 11. When the striker 15 is partially or completely behind the strike point in the striking direction 11, the pneumatic chamber 14 extends all the way to the vents 20 and is vented. The vents 20 can also be opened and closed by sleeves that actuate the striker 15 or the striking pin 16.

The striking pin 16 has a largely cylindrical core 21 and a collar 22 that surrounds a central section of the core 21. The core 21 is closed off along the working axis 10 by end faces 23, 24 that are essentially perpendicular to the working axis 10. The end faces 23, 24 form the impact-absorbing strike surface 23, onto which the striker 15 strikes, and the impact-generating strike surface 24, which strikes the drill bit 4. The strike surfaces 23, 24 can be slightly convex. The collar 22 has a cylindrical circumferential surface 25 and is closed off along the working axis 10 by end faces 26, 27 which are slanted vis-à-vis the working axis 10. The front end face 26, which faces the striker 15, is conical. The rear end face 27, which faces away from the striker 15, has a conical envelope. The mean slant 28 of the end faces 26, 27 is within the range from 30° and 70°.

The striking pin 16 runs in a bearing 29 on the working axis 10. The bearing 29 given by way of an example comprises a sleeve 30 against which the cylindrical circumferential surface 25 of the collar 22 of the striking pin 16 rests. The cylindrical material 31 of the core 21 for axially guiding the striking pin 16 can also rest against the sleeve 30. The bearing 29 limits the axial movement in the striking direction 11 by means of a catcher 32 and opposite from the striking direction 11 by means of a base 33. The base 33, which is, for example, annular, is in front of the collar 22 of the striking pin 23 in the striking direction 11. The core 21 can move freely in the opening of the base 33; the inner diameter of the base 33 is configured so as to be larger by a given amount of play than the diameter of the impact-absorbing strike surface 23. The diameter of the collar 22 is larger than the inner diameter of the base 33, as a result of which the collar 22 can rest on the base 33 opposite from the striking direction 11. The drill bit 4 being pressed down then presses the collar 22, that is to say, its end face 26 facing the striker 15, against the base 33, which corresponds to the working position of the striking pin 23 during operation. In the working position, the impact-absorbing strike surface 24 defines the strike point of the striking mechanism 3. The catcher 32 is arranged in front of the collar 22 in the striking direction 11. The catcher 32 is configured so as to be annular with an inner diameter that is larger than the diameter of the strike-generating strike surface 24 and smaller than the diameter of the collar 22. The end face 27 of the collar 22 that faces in the striking direction 11 can rest against the catcher 32 in the striking direction 11 since they overlap in the radial direction. The striking pin 16 is stopped by the catcher 32 once the striker 15 has struck the striking pin 16 in the absence of contact pressure from the tool 4. The catcher 32 can, as depicted, be configured as a constriction of the sleeve 30 or else as a separate component like the base 33 given by way of an example. The catcher 32 preferably has axial play in the power tool housing 12. The catcher 32 is supported in the striking direction 11 by means of a damping element 34 on the power tool housing 12. The catcher 32 preferably absorbs the kinetic energy of the striking pin 23 so that the striking pin 16 does not automatically slide back into the working position due to the recoil.

The striking pin 16 and its bearing 29 are provided with a connecting link 35 which causes the striking pin 16 to execute a rotational movement during its movement in the striking direction 11. The rotational movement has proven to be an effective measure to remove energy from the striking pin 16 at the time of impact into the catcher 32. As a result, the striking pin 16 comes to a standstill in the vicinity of the catcher 32 and does not accidentally slide back into the working position.

The connecting link 35 has, for example, a set of teeth 36 facing the catcher 32 on the rear end face 27 of the collar 22 and a set of teeth 37 on the catcher 32 facing the collar 22. These two sets of end face teeth 36, 37 are complementary to each other. The set of end face teeth 36 of the collar 22 can be configured as a beveled gear wheel 36 while the complementary set of end face teeth 37 of the catcher 32 has a concavely arched configuration. The striking pin 16 can be freely rotated around the working axis 10 in the bearing 29. For this reason, the angular orientation of the two end faces 26, 27 is largely random. As soon as the striking pin 16 strikes the catcher 32, the two end faces 26 orient themselves with respect to each other. On the average, the striking pin 16 rotates by one-fourth of the width of the teeth 38 of the set of end face teeth 36 relative to the catcher 32 until the two sets of end face teeth 36, 37 are oriented with respect to each other. Even though only a small portion of the translatory kinetic energy is converted into rotational energy, the connecting link 35 proves to have a pronounced damping effect. This strong damping is probably due to the dynamic inhibition that is created after both sets of end face teeth 36, 37 have become oriented. The sets of end face teeth 36, 37 then move apart along the working axis 10 due to the rotational movement of the striking pin 23, counter to the pulse from the striking pin 16 in the striking direction 11.

The set of end face teeth 36 of the collar 22 comprises several identical teeth 38 that are arranged so as to distributed consecutively at equal distances. The number of teeth 38 depends on the size of the striking pin 16, for example, this number is between 15 and 40. The top land line 40 of the tooth 38 is rectilinear and it is on the same plane as the working axis 10. In the set of end face teeth 38 of the collar 22, which is configured as a beveled gear wheel 36, the top land line 40 is slanted by between 30° and 70° relative to the working axis 10. In a different embodiment, the top land line can be skew-whiff relative to the working axis 10, whereby the top land line moves monotonically away from the working axis 10 from one end to the other. As an alternative, the top land line can have a spiral configuration. The tooth 38 has a flank 42 that faces only in the right-hand circumferential direction 41 and a flank 43 that faces only in the left-hand circumferential direction 39. The two flanks 42, 43 run towards each other in the striking direction 11 and converge in the top land line 40. The tooth 38 tapers in the striking direction 11. The slant 44 of the right-hand flank 42 is determined with respect to a reference plane 45. The reference plane 45 extends from the working axis 10 to the point on the flank 42 where the slant 44 is to be determined. The slant 44 is preferably within the range from 30° and 60°. The slant 46 of the left-hand flank 43 with respect to the reference plane 45 is preferably the same as the slant 44 of the right-hand flank 42. The two flanks 42, 43 can run towards each other in the direction of the working axis 10. Consequently, the tooth 38 is wider on its outside than closer to the working axis 10. The width of the tooth 38 preferably increases proportionally to the distance from the working axis 10. The angle width of the tooth 38 is thus constant along the radial direction. The height 47 of the teeth 38, that is to say, the dimension of the flanks 42, 43 along the working axis 10, is within the range from 2 mm to 5 mm.

The set of end face teeth 37 of the catcher 32 are designed to be complementary to the set of end face teeth 36 of the collar 22. The shape and number of interstices between the teeth 48 of the catcher 32 are the same as those of the teeth 38 of the collar 22. A left-hand flank 49 of the tooth 48 on the catcher 32 is largely congruent with the right-hand flank 42 of the tooth 38 on the collar 22; analogously, a right-hand flank of the tooth 48 on the catcher 32 is largely congruent with the left-hand flank 43 of the tooth 38 on the collar 22.

The catcher 32 can be mounted in the power tool housing 12 so as to be freely rotatable around the working axis 10. In particular, the catcher 32 is decoupled from the driven shaft 6. When the striking pin 23 strikes the catcher 32, both parts rotate relative to each other. The rotational energy transmitted by the striking pin 16 into the catcher 32 is removed from the striking mechanism 3. The damping element 34 is preferably non-rotatable in the power tool housing 12, as a result of which the catcher 32 moves relative to the damping element 34. The friction between the rubbery damping element 34 and the catcher 32 removes the kinetic energy from the striking pin 16.

As an alternative or in addition to the connecting link 35 with the sets of end face teeth 36, 37, a connecting link 50 can engage with a circumferential surface 25, 31 of the striking pin 23 in order to cause the striking pin 16 to execute a rotational movement. The connecting link 50 given by way of an example has a spiral groove 51 in the circumferential surface 31. The bearing 29 is provided with a runner 52 that engages in the groove 51. The runner 52 is joined to the bearing 29 in such a way that the runner 52 is immoveable with respect to the bearing 29 along the working axis 10 as well as in the circumferential direction 41. The runner 52 can be, for instance, a ball that is held in the bearing 29.

Preferably, the ball can turn around its center inside the holder. One flank of the runner 52 rests on a flank 53 of the groove 51 running at a slant to the working axis 10. The movement of the striking pin 23 along the working axis 10 forces a rotational movement of the striking pin 16 relative to the bearing 29. The groove 51 can have a constant pitch 54 along the working axis 10. The length of the entire groove 51 corresponds to the free path of the striking pin 23 between the base 33 and the catcher 32, typically within the range from 20 mm to 50 mm. Advantageously, the groove 51 runs parallel to the working axis 10 at an end facing the striker 15, and the pitch 54 increases in the striking direction 11. The parallel section can be between 4 mm and 10 mm long. The pitch 54 at the end of the groove 51 of the striking pin 23 on the tool side is between 30° and 60°. The ball can likewise be captured in the circumferential surface 31 of the striking pin 23 and the groove can be arranged inside the sleeve 30. Moreover, several identical grooves 51 can be provided around the working axis 10.

What is claimed is:

1-10. (canceled)

11. A chiseling handheld power tool comprising:
a tool socket to hold a chiseling tool coaxially to a working axis;
a motor;
a striking mechanism including an exciter forcibly excited by the motor periodically, a striker installed and movable coaxially to the working axis, a pneumatic chamber configured between the exciter and the striker so as to couple a movement of the striker to the movement of the exciter, and a striking pin behind the striker arranged in the striking direction for purposes of indirectly transmitting an impact from the striker to the chiseling tool held in the tool socket, the striking pin having a circumferential surface and an end face facing in the striking direction;
a bearing having a sleeve arranged coaxially to the working axis as well as a catcher, the circumferential surface of the striking pin being slidable on the sleeve, and the catcher being arranged in the striking direction of the end face of the striking pin in order to limit the movement of the striking pin in the striking direction,
a connecting link causing the striking pin to execute a rotation relative to the bearing when the striking pin moves in the striking direction, the connecting link having a flank on the striking pin and another flank on the bearing, whereby the flank and the other flank can rest against each other during movement and rise in the striking direction in the same circumferential direction.

12. The chiseling handheld power tool as recited in clam 11 wherein the connecting link has a set of teeth on the end face of the striking pin and a further set of teeth on the catcher.

13. The chiseling handheld power tool as recited in claim 12 wherein the set of end face teeth and the further set of teeth are configured so as to be complementary to each other.

14. The chiseling handheld power tool as recited in claim 13 wherein the set of end face teeth of the striking pin includes several identical teeth, and the flank of the striking pin being on each tooth, each tooth having a second flank running with the flank towards each other in the striking direction.

15. The chiseling handheld power tool as recited in claim 14 wherein a slant of the flanks is between 30° and 60°.

16. The chiseling handheld power tool as recited in claim 14 wherein a length of the flank and the second flank in the striking direction is within the range from 2 mm to 5 mm.

17. The chiseling handheld power tool as recited in claim 11 wherein the bearing is mounted in the power tool housing so as to be freely rotatable around the working axis.

18. The chiseling handheld power tool as recited in claim 11 wherein the catcher is rotatable around the working axis rests against an elastic damping element in the striking direction.

19. The chiseling handheld power tool as recited in claim 11 wherein the connecting link has a spiral groove forming the flank in a cylindrical circumferential surface of the striking pin and a runner defining the other flank engages into the groove from the bearing, or else the connecting link has a spiral groove that forms the flank in a cylindrical inner surface of the bearing and a runner defining the other flank engaging into the groove from the striking pin.

20. The chiseling handheld power tool as recited in claim 19 wherein the groove has a section that runs parallel to the working axis at a front end, as seen in the striking direction, and a pitch of the groove increases in the striking direction.
